(19) United States
(12) Patent Application Publication
(10) Pub. No.: US 2009/0309446 A1
(43) Pub. Date: Dec. 17, 2009

(54) ELECTRIC ARC WELDING SYSTEM POWERED BY PERMANENT MAGNET ELECTRIC GENERATOR

(76) Inventors: Terry D. Scott, Tulsa, OK (US); Johnny L. Scott, Tulsa, OK (US); Lawrence A. Hash, Sand Springs, OK (US)

Correspondence Address: STORM LLP, BANK OF AMERICA PLAZA, 901 MAIN STREET, SUITE 7100, DALLAS, TX, 75202, US

(21) Appl. No.: 12/138,650

(22) Filed: Jun. 13, 2008

(51) Int. Cl. H02P 9/14; H02K 1/12; H02M 7/04

(52) U.S. Cl. 310/156.01; 363/125; 310/216.004

(57) ABSTRACT

An electric arc welding system is powered by a power generator with a rotor assembly circumferentially surrounding a stator assembly. The arc welding system generates a three phase AC current, which is converted into a DC current by a converter. An electrode coupled to the converter receives the DC current, wherein a welding arc is created between the electrode and a workpiece. A controller is coupled to the converter. The controller is operable to apply a control signal to the converter to cause the converter to vary the magnitude of the DC current.

### FIELD OF THE INVENTION

The invention relates to an electric arc welding system. More specifically, the invention relates to an electric arc welding system powered by a permanent magnet electric generator with a rotor assembly circumferentially surrounding a stator assembly.

### BACKGROUND OF THE INVENTION

Arc welding systems are used to weld pipes, plates, rods and other metal structures and parts. Existing arc welding systems utilize a power source that is unsatisfactory in many aspects. The power source is typically heavy and thus difficult to transport. The arc wielding systems often require long cables because they are difficult to move. Some power sources have internal brush, thus requiring frequent maintenance and/or replacement of the brush. These power sources generally typically do not produce high frequency output current, thus requiring large output filters. Accordingly, improvement in arc welding systems is desired.

### SUMMARY OF THE INVENTION

An electric arc welding system includes an electric power generator operable to generate a three phase AC current. An ac-to-dc converter is coupled to the electric power generator. The ac-to-dc converter receives the three-phase AC current and is operable to output a DC current.

A controller is coupled to the ac-to-dc converter. The controller is operable to apply a control signal to the ac-to-dc converter to cause the ac-to-dc converter to vary the magnitude of the DC current. An electrode is coupled to the ac-to-dc converter for receiving the DC current, wherein a welding arc is created between the electrode and a work-piece.

The electric power generator is a permanent magnet electric generator, which includes a rotor assembly and a stator assembly. The rotor assembly includes an axially disposed annular outer ring, which is concentric with an axis of rotation. The rotor assembly also includes an axially disposed annular inner ring, which is concentric with the axis of rotation. The inner ring has a radius less than the radius of the outer ring, and the inner ring is disposed inside the outer ring.

A rotor frame is attached to the inner ring and the outer ring to define a radial gap between the inner and the outer rings. A rotor hub is concentric with the axis of rotation and is disposed inside the inner ring. The rotor hub is coupled to the inner ring by a hub frame mounted on the rotor hub. The rotor hub is adapted to be rotationally coupled to a shaft for rotating the rotor assembly.

A plurality of permanent magnets are disposed on the outer ring. Each magnet has a north pole and a south pole. The permanent magnets are aligned with the axis of rotation and adjacent magnets have alternating polarity. The hub frame includes a plurality of radially disposed blades attached to the inner ring. The hub frame is made from an insulating material. The inner ring is made from a plurality of thin, ring-shaped magnetically permeable material.

The stator assembly includes a plurality of stator blocks aligned to form an annular ring-shaped stator member retained by a stator frame. The stator member is configured to be at least partially disposed inside a rotor assembly and circumferentially encircled by the rotor assembly. The stator member is concentric with an axis of rotation. The stator member is wound with a three-phase winding extending through gaps between adjacent stator blocks. The stator block is formed by stacking a plurality of strips of magnetically permeable material. The three-phase winding extends laterally through the gaps of adjacent stator blocks. A heat sink is attached to the stator member to dissipate heat generated during operation of the electric generator.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1 illustrates an electric arc welding system in accordance with one example implementation.

FIG. 2 is a plan view of a rotor assembly for a permanent magnet electric generator in accordance with one embodiment.

FIG. 3 is a perspective view of a section of the rotor assembly.

FIG. 4 illustrates a wheel-shaped rotor frame with a circular opening at the center.

FIG. 5 is a cross-sectional view of the rotor assembly.

FIG. 6 is a perspective view of a stator assembly.

FIG. 7 is a perspective view of the rear side of the stator assembly.

FIG. 8 is a perspective view of an embodiment of the stator assembly with a section removed to illustrate its construction.

FIG. 9 shows a strip of an I-shaped material that forms the building block of a stator block.

FIG. 10 shows a stator block formed by a stack of the I-shaped strips.

FIG. 11 shows stator blocks wound by a three-phase winding.

FIG. 12 shows a stator member partially inserted inside a rotor assembly.

FIG. 13 illustrates a permanent magnet electric generator in accordance with one embodiment.

### DETAILED DESCRIPTION OF THE INVENTION

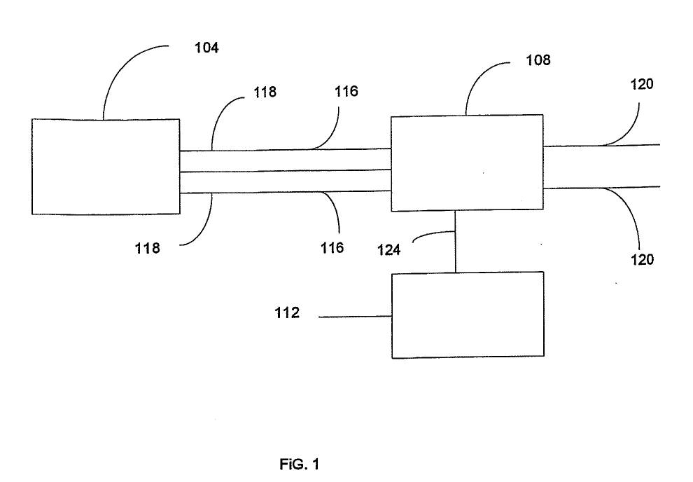

FIG. 1 illustrates an electric arc welding system 100 in accordance with one example implementation. The electric arc welding system 100 includes an electric power generator 104 operable to generate a three phase AC current 116. An ac-to-dc converter 108 is coupled to the electric power generator 104. The ac-to-dc converter 108 receives the three-phase AC current 116 over a three phase line 118 and generates a DC current 120. A controller 112 is coupled to the ac-to-dc converter 108. The controller 112 applies a control signal 124 to the ac-to-dc converter 108 to cause the ac-to-dc converter 108 to vary the magnitude of the DC current 120.

An electrode (not shown in FIG. 1) is coupled to the ac-to-dc converter 108 for receiving the DC current 120. A welding arc is created between the electrode and a work-piece that is being welded.

The ac-to-dc converter 108 may be a three phase rectifier that converts the three phase AC current 116 into the DC current 120. In one example implementation, the ac-to-dc converter 108 may be a switched converter that generates a controlled DC current responsive to the control signal 124. The switched converter may be implemented using thyristors, power MOSFETS or other power semiconductor devices. The control signal 124 may be adjusted by varying a knob or the like in the controller 112. Responsive to the magnitude of the control signal 124, the DC current 120 is varied.

In one implementation, an inductor (not shown in FIG. 1) may be connected in series with each phase of the three-phase line 118 between the electric power generator 104 and the ac-to-dc converter 108. The inductor is operable to filter harmonics from the three phase AC current 116.

In one implementation, a filter (not shown in FIG. 1) may be connected to the output of the ac-to-dc converter 108. The filter is operable to attenuate harmonics from the DC current 120. The filter may be an L-C filter or any other filter.

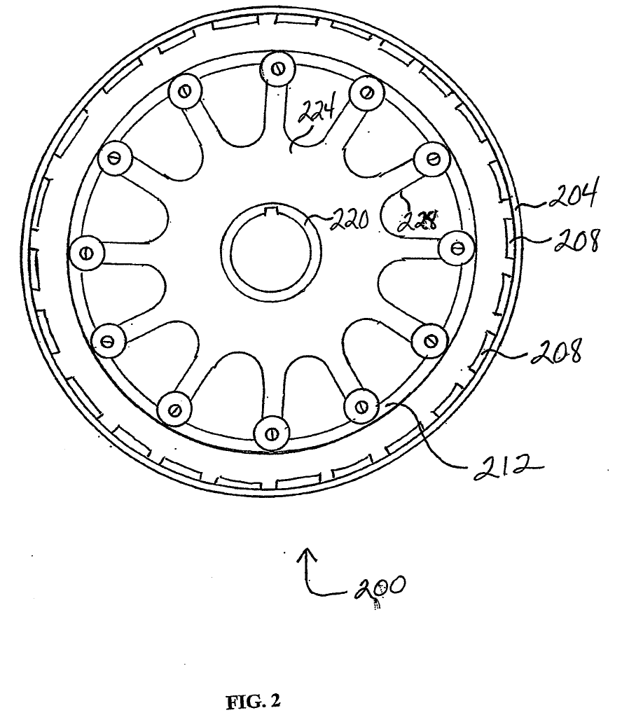

The electric power generator 104 is a permanent magnet electric generator. The permanent magnet electric generator includes a rotor assembly and stator assembly. FIG. 2 is a plan view of a rotor assembly 200 for a permanent magnet electric generator in accordance with one embodiment. The rotor assembly 200 includes an axially disposed annular outer ring 204. The outer ring 204 is concentric with an axis of rotation.

In one embodiment, the outer ring 204 is made from a magnetically, permeable material. For example, Carbon, Manganese or other suitable material can be used to make the outer ring 204. In one embodiment, the outer ring is made from DOM 1018 type cold roll steel. A plurality of permanent magnets 208 are distributed on the inner surface of the outer ring 204. In one embodiment, strips of permanent magnets 208 are substantially evenly distributed so that adjacent magnets have opposite north/south polarities. The permanent magnets are aligned with the rotational axis of the rotor assembly 200.

In one embodiment, the permanent magnets 208 are epoxy potted to the body of the outer ring 204, and/or may also be banded with wire to the body of the outer ring 204, to help retain the permanent magnets 208 in place at high rotational speeds. The permanent magnets 208 may be attached to the body of the outer ring 204 by other suitable means. As will be understood by those skilled in the art, the precise number of permanent magnets 208 will be determined by the number of rotor poles desired.

The rotor assembly 200 includes an axially disposed annular inner ring 212. The inner ring 212 is concentric with the axis of rotation and is disposed inside the outer ring. The radius of the inner ring 212 is less than the radius of the outer ring 204.

In one embodiment, the inner ring 212 is made from a plurality of ring-shaped strips. The ring-shaped strips are stacked to form the inner ring 212, thereby resulting in a laminated structure. The ring-shaped strips are made from a magnetically, permeable material. The strips can be epoxy potted or otherwise glued together to form the inner ring 212. The strips may also be stacked and attached with washers and screws. In one embodiment, the strips of inner rings are made from Silicon Grade 6 PHML.

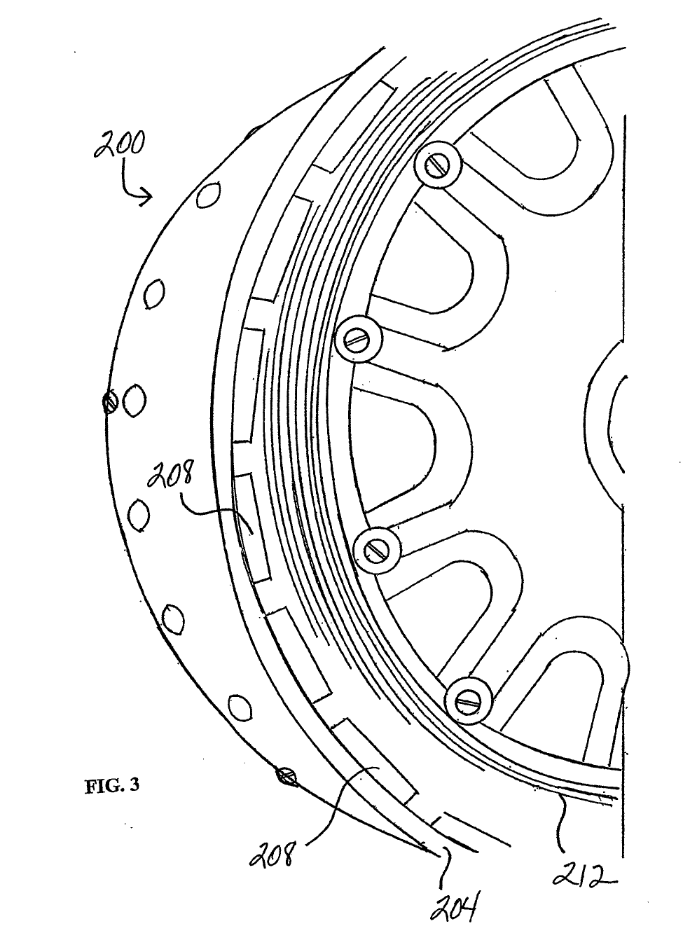

FIG. 3 is a perspective view of a section of the rotor assembly 200 illustrating the construction of the outer ring 204 and the inner ring 212. The outer ring 204 is made from a magnetically permeable material. A plurality of permanent magnets 208 are disposed on the outer ring 204. The inner ring 212 is constructed by a plurality of ring-shaped strips thereby forming a laminated construction as shown in FIG. 2. The inner ring 212 and the outer ring 204 are concentric with the axis of rotation. The inner ring 212 is disposed inside the outer ring 204.

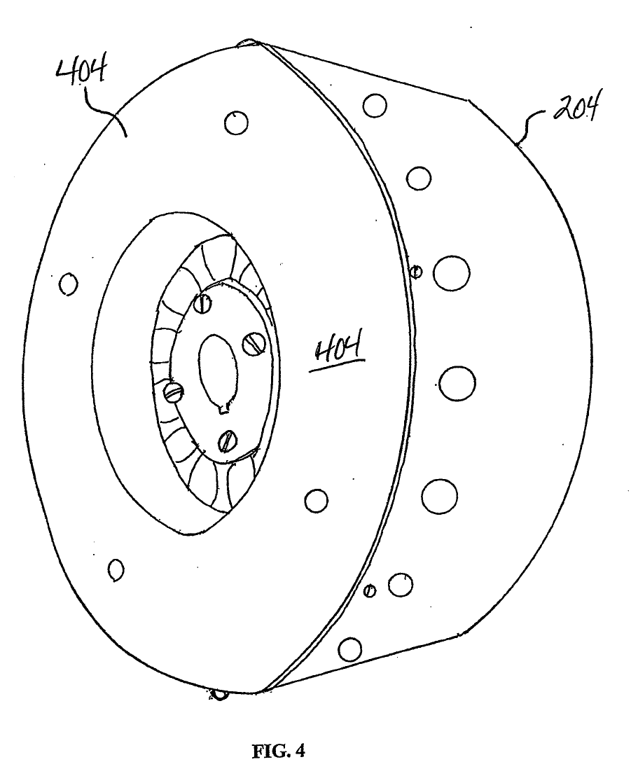

Referring now to FIG. 4, a wheel-shaped rotor frame 404 with a circular opening at the center securely retains the outer ring 204 and the inner ring 212 (not visible in FIG. 4). The rotor frame 404 concentrically aligns the inner and outer rings about the axis of rotation and defines a radial gap between the inner and the outer rings. The rotor frame 404 firmly retains the outer ring 204 and the inner ring 212 in alignment during high speed rotation of the rotor assembly 200. In one embodiment, the rotor frame 404 is made from a an electrically insulating, composite material.

Referring back to FIG. 2, the rotor assembly 200 includes a rotor hub 220 concentric with the axis of rotation. The rotor hub 220 is disposed inside the inner ring 212 and is coupled to the inner ring 212 by a hub frame 224. In one embodiment, the hub frame 224 includes a plurality of radially disposed blades 228 attached to the inner ring 212 to securely couple the inner ring 212 to the rotor hub 220. The rotor hub 220 is rotationally coupled to a shaft (not shown in FIG. 2) for rotating the rotor assembly 200. The shaft is coupled to source of rotational energy to rotate the rotor assembly. In one embodiment, the hub frame 224 is made from an electrically insulating, composite material.

As will be appreciated, the hub frame and the rotor frame cooperatively provide structural support to the rotor assembly 200. Also, when the rotor assembly 200 is in rotation, the rotor blades create air-flow that cools the rotor assembly 200.

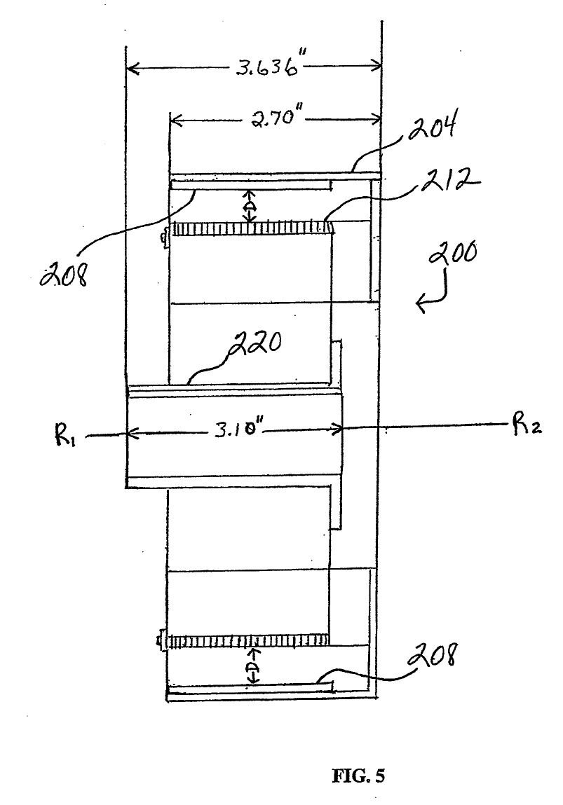

FIG. 5 is a cross-sectional view of the rotor assembly 200. The rotor assembly 200 comprises concentric inner and outer rings 212 and 204, respectively. The outer ring 204 is made from a magnetically permeable material. The inner ring 212 is made by bonding or stacking a plurality of ring-shaped pieces as indicated by its laminated structure. A plurality of permanent magnets 208 are attached to the inner surface of the outer ring 204. The poles of the magnets are aligned to the rotational axis of the rotor assembly indicated by the lines R1-R2. The outer and inner rings are aligned in place cooperatively by the rotor hub 220, the rotor frame and the hub frame. The hub 220 is sized to be coupled a shaft (not shown in FIG. 5), which turns the rotor assembly.

A radial gap D exists between the outer surface of the inner ring 204 and the permanent magnets. The radial gap D is determined by the radii of the inner and outer rings and the thickness of the permanent magnets. As will be explained later, a stator member is interposed between the inner and outer rings, inside the radial gap.

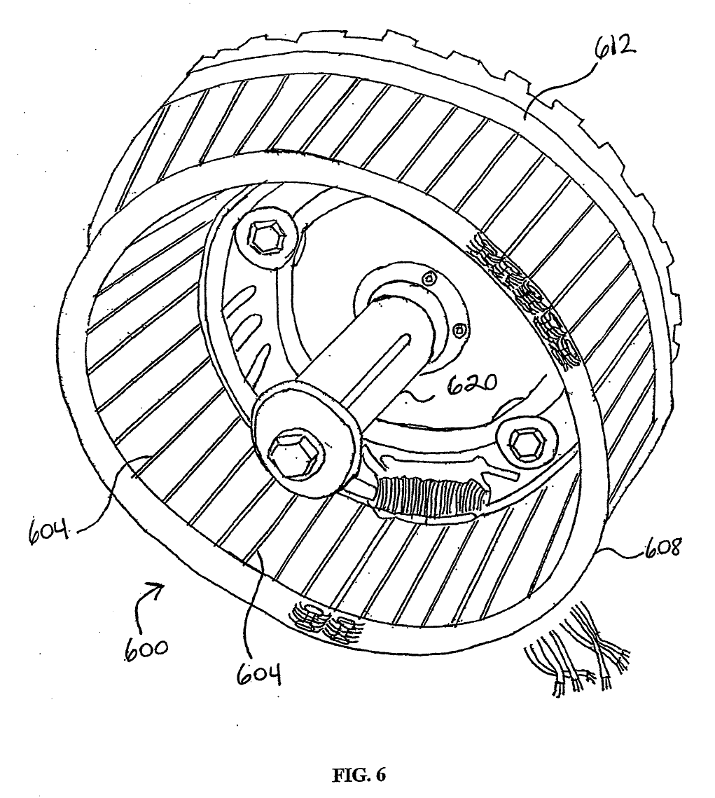

FIG. 6 is a perspective view of a stator assembly 600 of the permanent magnet electric generator. The stator assembly 600 includes a plurality of stator blocks 604, which are arranged in a ring-shape to form an annular stator member 608. The stator member 608 is wound with a three-phase winding (not shown in FIG. 6), thus forming a ring of wound wires. The precise number of the stator blocks 604 in the stator member 608 can be varied to influence the output characteristics of the generator.

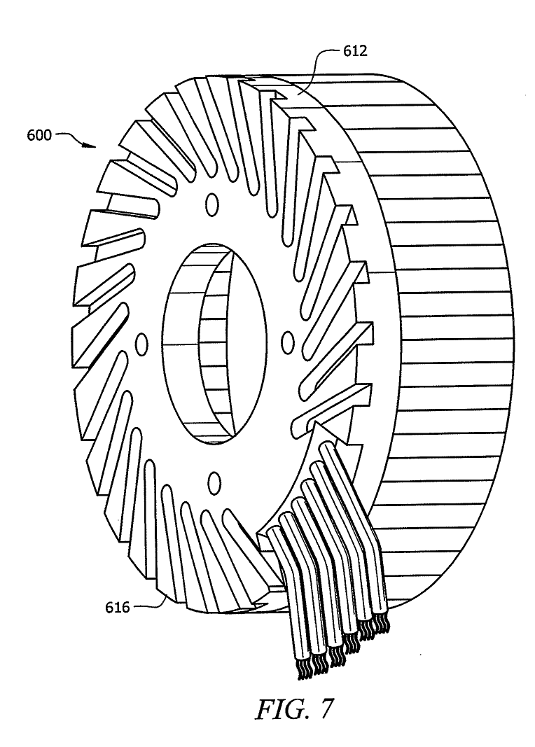

The stator member 608 is firmly mounted on a ring-shaped support member 612 by suitable means in order to retain the stator blocks 604 in alignment. FIG. 7 is a perspective view of the rear side of the stator assembly 600. The ring-shaped support member 612 may include a heat sink 616 sized to be attached to the support member 612. The heat sink 616 may be integrated with the support member 612. The heat sink 616 dissipates the heat generated in the stator assembly during operation. In one embodiment, 6061 type Aluminum may be used to make the heat sink.

A shaft 620 shown in FIG. 6 is encircled by the stator assembly 600. The shaft 620 is rotationally coupled to a source of rotational energy to turn a rotor assembly 200.

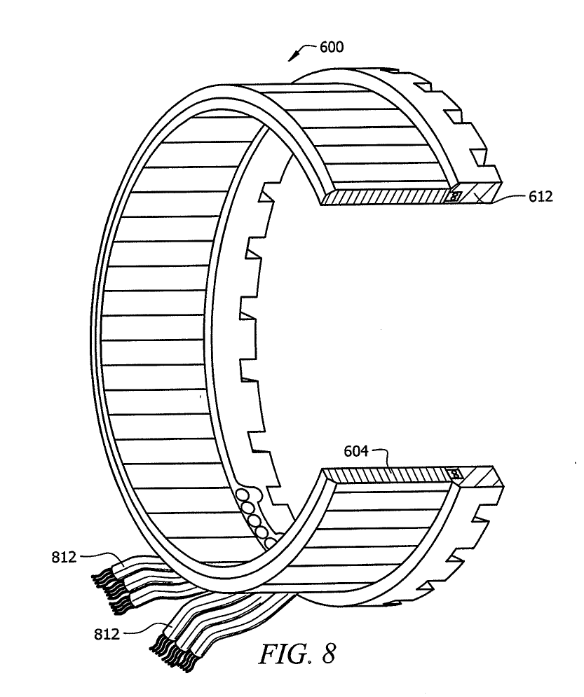

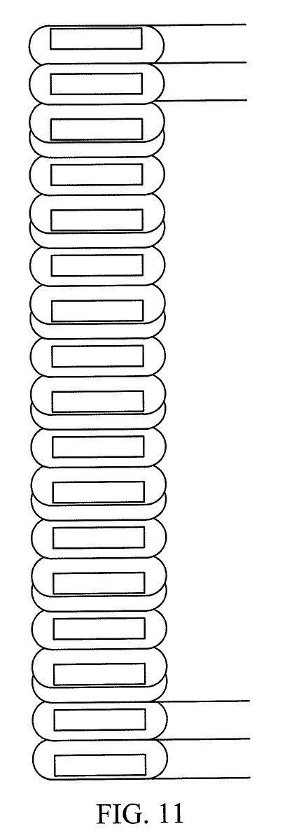

FIG. 8 is a perspective view of an embodiment of the stator assembly 600 with a section removed to illustrate its construction. The stator assembly 600 includes a plurality of stator blocks 604 that are wound with a three phase winding 812 for a three-phase voltage output. In one embodiment, the stator blocks 604 are wound in a manner so that three phase winding 812 passes through the gap between adjacent stator blocks 604. The stator blocks 604 are wound up as shown in FIG. 11 so that the three phase windings terminate into three pairs of externally accessible terminals or lead for a three phase voltage output.

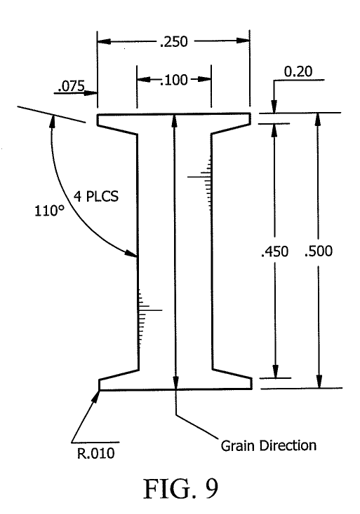

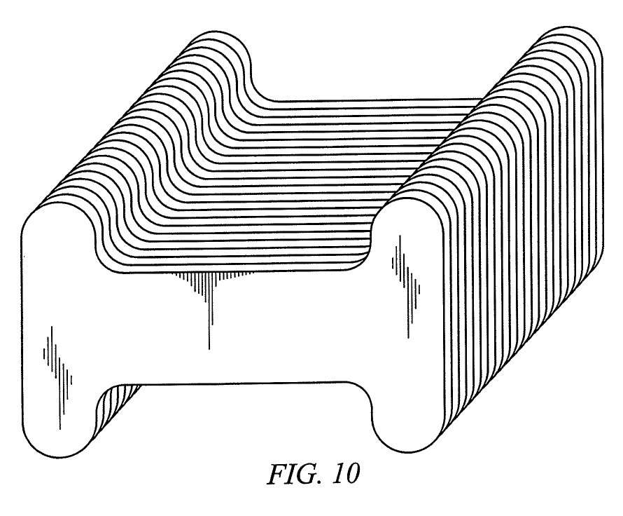

In one embodiment, the stator block 604 is formed by stacking a plurality of strips of non-magnetic, permeable material. In one embodiment, strips of I-shaped magnetically, permeable material are stacked to form a stator block. For example, strips of M6-29 Gage material having consistent grain direction can be used to form a stator block. In one embodiment, Silicon Grade 6 PHML may be used to form the strips. FIG. 9 shows a strip of an I-shaped material that forms the building block of a stator block. FIG. 10 shows a stator block formed by a stack of the I-shaped strips, and FIG. 11 shows stator blocks wound by a three-phase winding.

In one embodiment, after the stator blocks 604 are wound by the three-phase winding, the stator blocks 604 are epoxy potted or otherwise secured together to form a rigid, annular structure. The rigid annular structure is then mounted on the ring-shaped support structure 612 shown in FIGS. 7 and 8.

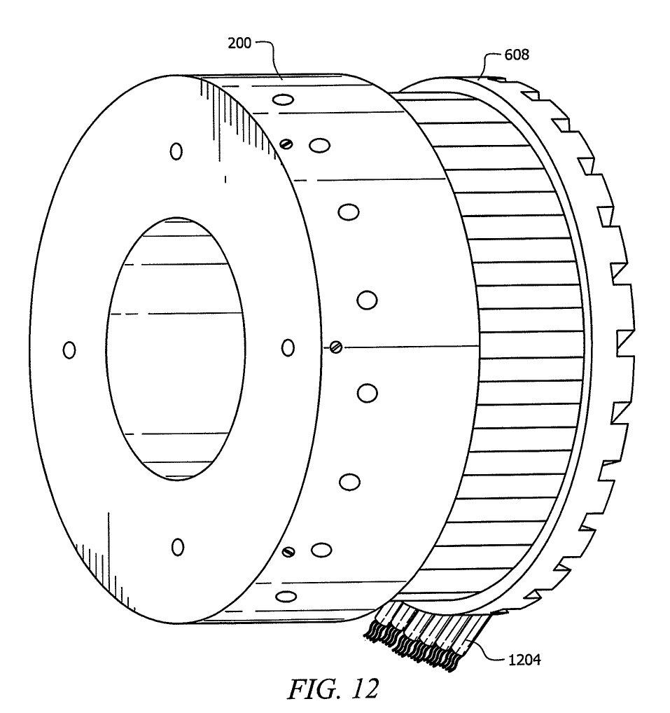

FIG. 12 shows the stator member 608 partially inserted inside the rotor assembly 200. As discussed before, the stator member 608 is interposed between the inner and outer rings. When the electric generator is fully assembled, the stator member 608 is circumferentially encircled by the rotor assembly 200. The stator member 608 resides within the radial gap between the inner and outer rings of the rotor assembly. Thus, the rotor assembly 200 rotates encircling the stator member 608. As shown in FIG. 12, leads 1204 of the three phase winding for a three-phase output are accessible. The leads 1204 of the three phase winding are electrically coupled to the three phase line 118 (shown in FIG. 1) to deliver the three phase AC current 116 to the ac-to-dc converter 108.

As will be appreciated by those skilled in the art, upon assembly the stator member 608 is encircled by the outer ring 204 of the rotor assembly 200, while the inner ring 212 of the rotor assembly is encircled by the stator member 608. During operation, each stator block 604 can supply a specific amount of current at a specific voltage, depending on the construction of the stator block 604 and the rotational force of the magnets attached to a rotor assembly passing in close proximity to the stator blocks 604. Based on the principle that moving magnets create electrical currents in closed circles of wire, electrical energy is generated when the rotor assembly 200, rotationally coupled to a source of rotational energy, is rotated at high speed encircling the stator member 608.

As will be appreciated, only the stator assembly 600, which is the stationary member, have windings. The rotor assembly 200, which is the rotational member does not include any winding. As such the generator does not require any brush contacts, which makes the generator reliable and relatively maintenance free.

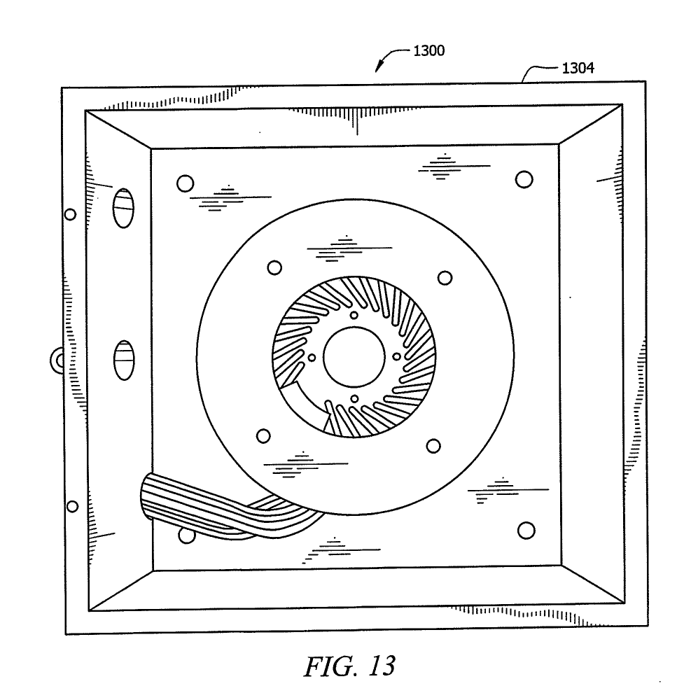

FIG. 13 illustrates a permanent magnet electric generator 1300 in accordance with one embodiment. The generator includes a housing 1304 which houses the stator assembly and the rotor assembly discussed above. The shaft is rotationally coupled to a source of rotational energy to rotate the rotor assembly (not shown in FIG. 13).

In one embodiment, 24 permanent magnets were attached to the inner surface of the outer ring 204. In one embodiment, the permanent magnets were made from H27 type material. In one embodiment, 73 stator blocks were used to construct the stator member. In one embodiment, Silicon grade M29 laminations were used to construct the stator blocks.

In one implementation, the permanent magnet electric generator 104 (shown in FIG. 1) and 1300 (shown in FIG. 13) is a compact, light-weight, low maintenance power generator. In one example implementation, the permanent magnet electric generator was operated to generate 20V and 250 Amp DC at the output of the rectifier (or ac-to-dc converter). In one implementation, the DC output current at the output of the rectifier (or ac-to-dc converter) can be varied from 30 Amp to 250 Amp. Open circuit voltage was measured at 72 V.

In one example implementation, the arc weld system was fitted with electrodes having size 1/16 inch to ¼ inch. Since the electric power generator is light-weight and compact, it is easy to transport to a job site. Also, there is no need for long cables since the electric power generator is easily transportable. Also, since the power generator does not have a brush, it is a low maintenance generator.

The arc welding system 100 exhibits superior welding performance characteristics. The electric power generator can generate high frequency AC output, which is converted to the DC current by the rectifier. The arc welding system performs well with various types of electrodes including, but not limited, to 6011/7018 Nickel-Chrome. The arc welding system also performs well under harsh environmental conditions.

It will be apparent to those of skill in the art that the number of stator elements 104 and the magnets may be varied to suit the desired characteristics of the generator. Also, the relative size and precise configuration of various components and elements of the generator may be varied.

It will be appreciated by those skilled in the art that changes could be made to the embodiments described above without departing from the broad inventive concept thereof It is understood, therefore, that this invention is not limited to the particular embodiments disclosed, but it is intended to cover modifications within the spirit and scope of the present invention as defined by the appended claims.

What is claimed is:

1. An electric arc welding system, comprising:
an electric power generator operable to generate a three phase AC current;
an ac-to-dc converter coupled to the electric power generator, the ac-to-dc converter receiving the three-phase AC current and operable to output a DC current;
a controller coupled to the ac-to-dc converter, the controller operable to apply a control signal to the ac-to-dc converter to cause the ac-to-dc converter to vary the magnitude of the DC current;
an electrode coupled to the ac-to-dc converter for receiving the DC current, wherein a welding arc is created between the electrode and a work-piece;
the electric power generator comprising:
a rotor assembly, comprising:
an axially disposed annular outer ring being concentric with an axis of rotation;
an axially disposed annular inner ring being concentric with the axis of rotation, the inner ring having a radius less than the radius of the outer ring, the inner ring being disposed inside the outer ring;
a rotor frame attached to the inner ring and the outer ring to define a radial gap between the inner and the outer rings;
a rotor hub concentric with the axis of rotation and disposed inside the inner ring, the rotor hub being coupled to the inner ring by a hub frame mounted on the rotor hub, the rotor hub adapted to be rotationally coupled to a shaft for rotating the rotor assembly;
a plurality of magnets disposed on the outer ring, each magnet having a north pole and a south pole;
a stator assembly, comprising a plurality of stator blocks aligned to form an annular ring-shaped stator member retained by a stator frame, the stator member configured to be at least partially disposed between the inner and outer rings of the rotor assembly and circumferentially encircled by the outer ring of the rotor assembly, the stator member being concentric with the axis of rotation, each stator block formed with a plurality of strips, the stator member wound with a three-phase winding extending through gaps between adjacent stator blocks, wherein AC current is generated in the three-phase winding by rotation of the rotor assembly in relation to the stator assembly.

2. The electric arc welding system of claim 1, wherein the ac-to-dc converter is a three phase rectifier operable to generate the DC current.

3. The electric arc welding system of claim 1, wherein the ac-to-dc converter is a rectifier configured to receive the control signal from the controller and operable to adjust the DC current in response to the control signal.

4. The electric arc welding system of claim 1 further comprising an inductor connected in series with each phase of a three-phase line between the electric power generator and the ac-to-dc converter.

5. The electric arc welding system of claim 1 further comprising a filter coupled to the output of the ac-to-dc converter, the filter operable to attenuate harmonics from the current.

6. The electric arc welding system of claim 5 further comprising an L-C filter coupled to the output of the ac-to-dc converter, the L-C filter operable to attenuate harmonics from the DC current.

7. An electric arc welding system, comprising:
an electric power generator operable to generate a three phase AC current;
a three-phase switched rectifier coupled to the electric power generator, the three-phase switched rectifier receiving the three-phase AC current and operable to output a DC current;
a controller coupled to the three-phase switched rectifier, the controller operable to provide a control signal to the three-phase switched rectifier to cause the rectifier to vary the magnitude of the DC current;
a filter coupled to the three-phase switched rectifier, the filter receiving the DC current from the rectifier and operable to attenuate harmonics from the DC current;
an electrode coupled to the three-phase switched rectifier for receiving the DC current, wherein a welding arc is created between the electrode and a workpiece;
the electric power generator comprising:
a rotor assembly, comprising:
an axially disposed annular outer ring being concentric with an axis of rotation;
an axially disposed annular inner ring being concentric with the axis of rotation, the inner ring having a radius less than the radius of the outer ring, the inner ring being disposed inside the outer ring;
a rotor frame attached to the inner ring and the outer ring to define a radial gap between the inner and the outer rings;
a rotor hub concentric with the axis of rotation and disposed inside the inner ring, the rotor hub being coupled to the inner ring by a hub frame mounted on the rotor hub, the rotor hub adapted to be rotationally coupled to a shaft for rotating the rotor assembly;
a plurality of magnets disposed on the outer ring, each magnet having a north pole and a south pole;
a stator assembly, comprising a plurality of stator blocks aligned to form an annular ring-shaped stator member retained by a stator frame, the stator member configured to be at least partially disposed between the inner and outer rings of the rotor assembly and circumferentially encircled by the outer ring of the rotor assembly, the stator member being concentric with the axis of rotation, each stator block formed with a plurality of strips, the stator member wound with a three-phase winding extending through gaps between adjacent stator blocks, wherein electricity is generated in the three-phase winding by rotation of the rotor assembly in relation to the stator assembly.

8. The electric arc welding system of claim 7 further comprising an inductor connected in series with each phase of the three-phase line between the electric power generator and the three-phase switched rectifier.

9. The electric arc welding system of claim 7, wherein the filter is an L-C filter coupled to the output of the three-phase switched rectifier, the L-C filter operable to attenuate harmonics from the DC current.

10. An electric arc welding system, comprising:
an electric power generator operable to generate a three phase AC current;
an ac-to-dc converter coupled to the electric power generator, the ac-to-dc converter receiving the three-phase AC current and operable to output a DC current;
a controller coupled to the ac-to-dc converter, the controller configured to receive an input signal and operable responsive to the input signal to provide a control signal to the ac-to-dc converter to cause the ac-to-dc converter to vary the magnitude of the DC current;
an electrode coupled to the ac-to-dc converter for receiving the DC current, wherein a welding arc is created between the electrode and a workpiece;
the electric power generator comprising:
a rotor assembly having an axially disposed annular outer ring being concentric with an axis of rotation, an axially disposed annular inner ring being concentric with the axis of rotation, the inner ring having a radius less than the radius of the outer ring, the inner ring being disposed inside the outer ring, a rotor frame attached to the inner ring and the outer ring to define a radial gap between the inner and the outer rings, a rotor hub concentric with the axis of rotation and disposed inside the inner ring, the rotor hub being coupled to the inner ring by a hub frame mounted on the rotor hub, the rotor hub adapted to be rotationally coupled to a shaft for rotating the rotor assembly, and a plurality of magnets disposed on the outer ring, each magnet having a north pole and a south pole.

11. The electric arc welding system of claim 10, wherein the ac-to-dc converter is a three phase rectifier operable to generate the DC current.

12. The electric arc welding system of claim 10, wherein the ac-to-dc converter is a rectifier configured to receive the control signal from the controller and operable to adjust the DC current in response to the control signal.

13. The electric arc welding system of claim 10 further comprising an inductor connected in series with each phase of a three-phase line between the electric power generator and the ac-to-dc converter.

14. The electric arc welding system of claim 10 further comprising a filter coupled to the output of the ac-to-dc converter, the operable to attenuate harmonics from the current.

15. The electric arc welding system of claim 10 further comprising an L-C filter coupled to the output of the ac-to-dc converter, the L-C filter operable to attenuate harmonics from the DC current.
